(19) United States
(12) Patent Application Publication
(10) Pub. No.: US 2017/0039605 A1
(43) Pub. Date: Feb. 9, 2017

(54) METHOD AND SYSTEM FOR PROVIDING A PERSONALISED CUSTOMER SERVICE FROM A PHYSICAL PROVIDER OF GOODS OR SERVICES

(71) Applicant: MasterCard International Incorporated, Purchase, NY (US)

(72) Inventors: Shweta Khattar, New Delhi (IN); Amit Gupta, New Delhi (IN); Nidhi Taneja, New Delhi (IN)

(21) Appl. No.: 15/227,331

(22) Filed: Aug. 3, 2016

(30) Foreign Application Priority Data
Aug. 4, 2015 (SG) 10201506111S

(51) Int. Cl. G06Q 30/02; G06Q 30/00; G06Q 30/06; H04B 5/00

(52) U.S. Cl. CPC G06Q 30/0281; H04B 5/0062; G06Q 30/016; G06Q 30/0631; G06Q 30/0625; G06Q 30/0224; G06Q 30/0255

(57) ABSTRACT

A computer-implemented method is proposed for providing a personalized customer service from a physical provider of goods or services. The method comprises: automatically recognizing when a customer enters a physical provider of goods or services through use of an electronic signature; obtaining data on the recognized customer, the data comprising the customer's historical purchasing data; and informing provider staff of one or more of: the customer data, deals, discounts, recommendations or rewards to offer the customer based on the historical purchasing data, such that the staff can provide a personalized service to the customer based on the data provided.

### CROSS-REFERENCE TO RELATED APPLICATION

This application is a U.S. National Stage filing under 35 U.S.C. §119, based on and claiming benefit of and priority to SG Patent Application No. 10201506111S filed Aug. 4, 2015.

### FIELD OF THE INVENTION

The present invention relates to a method and system for providing a personalised customer service from a physical provider of goods or services. The invention is applicable to face-to-face customer service interactions in which the customer is physically present in a bricks and mortar shop, restaurant, bar etc. as opposed to an online customer experience.

### BACKGROUND

It is known to provide a personalised customer service to online customers by virtue of a customer logging in to a website with details that can uniquely be linked to the customer's past purchases at that website. In which case, the website may welcome the customer by name and recommend specific products/services based on past purchases. However, such websites generally only have access to data regarding previous purchases through that one particular website (or group of websites) and no information is available regarding similar purchases through other (non-affiliated) websites.

A personalised customer service is not currently available in most physical shops, restaurants and bars etc. unless a specific customer is known as a regular patron to a specific staff member. However, this generally only applies to single outlets and cannot currently be replicated at sister outlets or unrelated outlets of a similar kind (i.e. all Italian Restaurants). It is therefore an aim of the present invention to provide an improved experience for customers in the real (as opposed to virtual) world.

A known proposal for an improved shopper experience (ShopBeacon™) uses a location-specific application (“app”) on a mobile device in order to determine when a customer is in a particular shop, to welcome the shopper to the shop and to offer the shopper deals, discounts, recommendations and rewards, without the shopper having to remember to open the app. Furthermore, the app can link past browsing to in-store prompts (for example, if the shopper “likes” a specific product in the app catalogue, the system can remind the shopper when he/she enters the store that sells it). Thus, although this system is tailored to the customer to provide location-specific information it does not take into account historical purchasing data. In addition, this known system is implemented through a mobile device and does not provide an improved personalised customer service between the customer and staff of the physical provider.

It is therefore an aim of the present invention to provide an improved method and system for providing a personalised customer service from a physical provider of goods or services.

### SUMMARY OF THE INVENTION

In accordance with a first aspect of the invention there is provided a computer-implemented method for providing a personalised customer service from a physical provider of goods or services comprising:

(i) automatically recognising when a customer enters a physical provider of goods or services through use of an electronic signature;
(ii) obtaining data on the recognised customer, the data comprising the customer's historical purchasing data; and
(iii) informing provider staff of one or more of: the customer data, deals, discounts, recommendations or rewards to offer the customer based on the historical purchasing data, such that the staff can provide a personalised service to the customer based on the data provided.

As used herein, the term ‘purchasing data’ may comprise information relating to the purchase of any goods or services (together referred to as products) and may comprise an itemised listing of the purchased products (e.g. as collected by a merchant) in addition to traditional transactional data (e.g. collected by a payment network) which may comprise cost, location and time of purchase etc.

Embodiments of the present invention have the advantage that a personalised customer service can be delivered by staff of a physical provider of goods/services without requiring the customer to initiate the interaction (e.g. by actively registering themselves or responding to prompts on a mobile device). Accordingly, the invention facilitates a personalised real-time face-to-face encounter between the customer and staff of the provider when the customer enters the physical establishment, even if the customer and staff have never previously met. Advantageously, implementation of the method may be invisible to the customer although the personal service provided to them will be tailored to their data profile. This may mimic the customer service often received online but applies it to the physical (as opposed to virtual) world.

Embodiments of the invention may be particularly suited to improving the customer service in food and beverage outlets (e.g. restaurants, cafes, bars, clubs etc.). However, aspects of the invention may also be employed to improve the customer experience at other goods/services providers (e.g. retail outlets, banks, post-offices, travel agents etc.).

It should be noted that although many shops/restaurants record itinerary level data for each of their customers, they don't currently have the tools, processes or systems to effectively utilise this data to offer a better service in order to improve customer engagement or loyalty. Furthermore, it is believed that most customers would appreciate a better level of service at such establishments, for example, by being offered similar items to those they purchased previously and this may increase the loyalty of the customer to that establishment. Moreover, many goods/services providers do not have a sufficient level of customised incentives or offers to provide to their customers, for example, in terms of loyalty points that can be redeemed at their outlet(s).

The electronic signature may conveniently be provided via a near-field communication (NFC) chip (e.g. a radio frequency identification, RFID, tag or similar), provided on a loyalty card, key-ring or the like. In some embodiments, the electronic signature may be provided by a payment card or mobile device.

As used in this document, the term “payment card” refers to any suitable cashless payment device, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, transponder devices, NFC-enabled devices, tablets and/or computers.

The data may comprise one or more of: a customer ID code, customer name, address, demographics, transaction dates, transaction amounts, items purchased (e.g. stock keeping units, SKU's), goods/services provider information (including references to any associated group members); statistics on frequency of visits to each goods/services provider over a pre-defined period and level of spend per visit; provider type and sub-category (i.e. restaurant: Italian); statistics on frequency of visits to each provider type and/or sub-category and level of spend per visit.

In embodiments of the present invention, historical purchasing data is used to predict future customer behaviour (e.g. future spend patterns) so that tailored deals, discounts, recommendations or rewards can be offered to the customer.

The step of obtaining data on the recognised customer may comprise reading data from a local source, for example, the source of the electronic signature. In which case, both the electronic signature and the data may be provided on a single source such as a loyalty card, key-ring or payment card. In other embodiments, the data may be stored remotely (e.g. in a cloud server) and accessed via a personal identification number, which may comprise the electronic signature.

A full purchasing history may be available to all service providers so they can extract information relating to purchases at a plurality of service providers (i.e. not just data on previous purchases with themselves). For example, the method may comprise considering all purchases relating to a particular provider type and/or sub-category (i.e. all cocktail bars or all Chinese restaurants). In some embodiments, the method may comprise determining the customer's preferences and/or typical spending patterns by comparing the number and types of providers the customer has transacted with over a pre-defined time period. In this way, the method may comprise determining the customer's favourite restaurants or favourite types of cuisine at various times of the day, week, month or year. For example, a customer may prefer to eat at relatively inexpensive or local restaurants during the working week and at more expensive or more remote restaurants at weekends.

The method may comprise using the data obtained on the recognised customer to predict future spending. This may comprise predicting the next time a customer may visit a particular provider of goods/services or a particular type and/or sub-category of provider. It may also comprise predicting the kind of items the customer may purchase from each provider and/or type and/or sub-category of provider. This information may be stored in a preference database, which may be stored on a local source or a remote server.

The method may enable to the staff to greet the customer by name and/or suggest goods/services (e.g. particular menu items) based on previous selections.

In particular embodiments, the staff may be informed of specific offers or incentives, which may comprise bundled offers, to provide to the customer based on their historical purchasing data.

In addition, the method may comprise analysing data from a plurality of customers and providing information to providers of goods/services based on one or more groups of customers. For example, if a group of customers based in a first area often travel to a second area to frequent a particular provider of good/services, the method may identify the opportunity for the provider to open a branch in the first area on the basis of the location and density of its customers.

The step of informing the staff may comprise providing the data on an electronic device (e.g. a mobile phone, Smartphone, personal digital assistant (PDA), key fob, transponder device, NFC-enabled device, tablet or computers).

In accordance with a second aspect of the invention there is provided a computer system for providing a personalised customer service from a physical provider of goods or services comprising:

(i) a detector for recognising when a customer enters a physical provider of goods or services through use of an electronic signature;
(ii) a database comprising data on the recognised customer, the data comprising the customer's historical purchasing data; and
(iii) a processor for informing provider staff of one or more of: the customer data, deals, discounts, recommendations or rewards to offer the customer based on the historical purchasing data, such that the staff can provide a personalised service to the customer based on the data provided.

The invention may be implemented in the form of a centralised computer system (e.g. a server) which presents an interface to which operators (i.e. staff) may connect (e.g. over the internet). Alternatively, it may be provided as an application (“app”) running on an operator-owned computing device, optionally communicating with external database(s).

The optional method features described above may be implemented using the computer system according to the second aspect of the invention.

In accordance with a third aspect of the invention there is provided a non-transitory computer-readable medium having stored thereon program instructions for causing at least one processor to perform the method according to the first aspect of the invention.

In accordance with a fourth aspect of the invention there is provided a NFC device for communicating an electronic signature identifying a customer when the customer enters a physical provider of goods or services.

In accordance with a fourth aspect of the invention there is provided an electronic device for informing provider staff of one or more of: customer data, deals, discounts, recommendations or rewards to offer a customer based on the customer's historical purchasing data, such that the staff can provide a personalised service to the customer based on the data provided.

### BRIEF DESCRIPTION OF THE DRAWINGS

Embodiments of the invention will now be described, by way of example only, with reference to the following drawings, in which:

FIG. 1 is a flowchart of a method according to an embodiment of the present invention; and

FIG. 2 is a block diagram of a computer system according to an embodiment of the present invention.

### DETAILED DESCRIPTION OF CERTAIN EMBODIMENTS

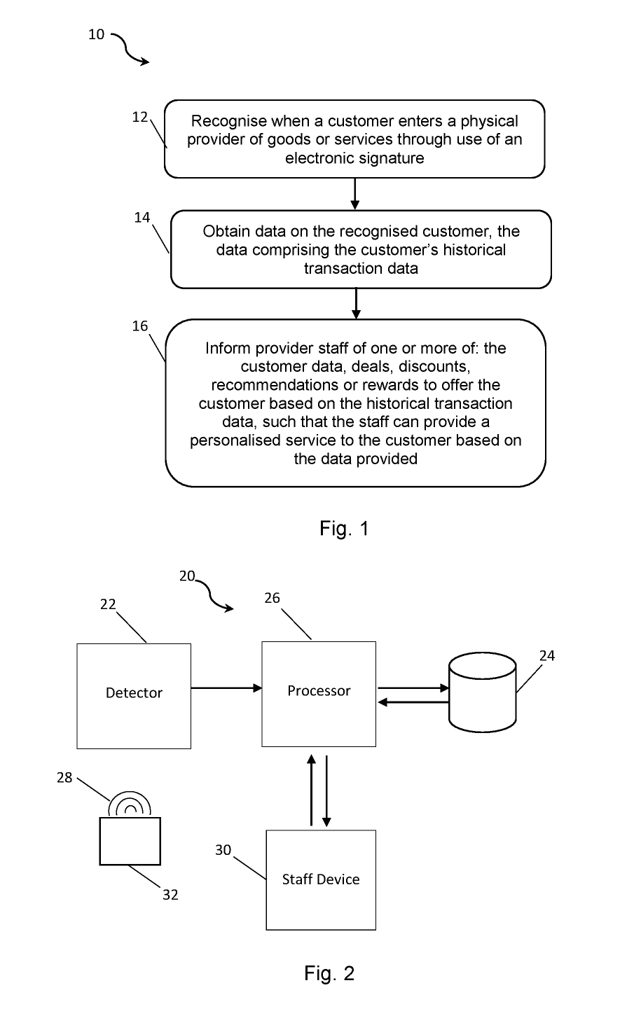

In accordance with an embodiment of the present invention there is provided a computer-implemented method 10 for providing a personalised customer service from a physical provider of goods or services, as illustrated in FIG. 1. In particular, the method comprises the following steps:

Step 12: recognising when a customer enters a physical provider of goods or services through use of an electronic signature;

Step 14: obtaining data on the recognised customer, the data comprising the customer's historical purchasing data; and

Step 16: informing provider staff of one or more of: the customer data, deals, discounts, recommendations or rewards to offer the customer based on the historical purchasing data, such that the staff can provide a personalised service to the customer based on the data provided.

FIG. 2 shows a block diagram of a computer system 20 according to an embodiment of the present invention. The computer system 20 is configured for providing a personalised customer service from a physical provider of goods or services, in accordance with the method described above, and comprises a detector 22, a database 24 and a processor 26. The detector 22 is configured to recognise when a customer enters a physical provider of goods or services through use of an electronic signature 28. The database 24 comprises data on the recognised customer that includes the customer's historical purchasing data. The processor 26 is configured to inform provider staff of one or more of: the customer data, deals, discounts, recommendations or rewards to offer the customer based on the historical purchasing data, such that the staff can provide a personalised service to the customer based on the data provided. The staff may be provided with the data through an electronic staff device 30, which may be in the form of a tablet computer. Furthermore, the electronic signature 28 may be communicated by a NFC chip on a loyalty card 32.

Although not shown, the computer system 20 may further comprise a GUI for presenting information to an operator. Furthermore, the computer system 20 may comprise a distributed system with one or more components (e.g. databases) distributed over a network (i.e. the internet). Alternatively, the computer system 20 may comprise a personal computer (PC) or a mobile device, such as a tablet computer or a smartphone.

As explained above, embodiments of the present invention have the advantage that a personalised customer service can be delivered by staff of a physical provider of goods/services without requiring the customer to initiate the interaction. The invention may be particularly suited to improving the customer service in food and beverage outlets as well as at other goods/services providers (e.g. retail outlets, banks, post-offices, travel agents etc.).

In the embodiment illustrated, the data comprises one or more of: a customer ID code, customer name, address, demographics, transaction dates, transaction amounts, items purchased (e.g. stock keeping units, SKU's), goods/services provider information (including references to any associated group members); statistics on frequency of visits to each goods/services provider over a pre-defined period and level of spend per visit; provider type and sub-category (i.e. restaurant: Italian); statistics on frequency of visits to each provider type and/or sub-category.

Historical purchasing data is also used to predict future customer behaviour (e.g. future spend patterns) so that tailored deals, discounts, recommendations or rewards can be offered to the customer. This comprises predicting the next time a customer may visit a particular provider of goods/services or a particular type and/or sub-category of provider. It also comprises predicting the kind of items the customer may purchase from each provider and/or type and/or sub-category of provider. This information is stored in a preference database (which may form part of database 24).

In this embodiment, a full purchasing history is available to all service providers so they can extract information relating to purchases at a plurality of service providers. The method also comprises determining the customer's preferences and typical spending patterns by comparing the number and types of providers the customer has transacted with over a pre-defined time period (i.e. month). In this way, the method comprises determining the customer's favourite restaurants or favourite types of cuisine at various times of the day, week, month or year.

The method not only enables the staff to greet the customer by name but also to suggest goods/services (e.g. particular menu items) based on previous selections by that customer.

In addition, the method comprises analysing data from a plurality of customers and providing information to providers of goods/services based on one or more groups of customers. For example, if a group of customers based in a first area often travel to a second area to frequent a particular provider of good/services, the method may identify the opportunity for the provider to open a branch in the first area on the basis of the location and density of its customers.

Although only a single system and method according to embodiments of the present invention have been described in detail, many variations are possible in accordance with the appended claims.

1. A computer-implemented method for providing a personalized customer service from a physical provider of goods or services comprising:
(i) automatically recognizing when a customer enters a physical provider of goods or services through use of an electronic signature;
(ii) obtaining data on the recognized customer, the data comprising the customer's historical purchasing data; and
(iii) informing provider staff of one or more of: the customer data, deals, discounts, recommendations or rewards to offer the customer based on the historical purchasing data, such that the staff can provide a personalized service to the customer based on the data provided.

2. The method according to claim 1, wherein the provider comprises one or more of: a food and/or beverage outlet, a retail outlet, a bank, a post-office or a travel agent.

3. The method according to claim 1, wherein the electronic signature is provided via a near-field communication (NFC) chip.

4. The method according to claim 1, wherein the electronic signature is provided on a loyalty card, key-ring, payment card or mobile device.

5. The method according to claim 1, wherein the data comprises one or more of: a customer ID code, customer name, address, demographics, transaction dates, transaction amounts, items purchased, goods/services provider information; statistics on frequency of visits to each goods/services provider over a pre-defined period and/or level of spend per visit; provider type and sub-category; and statistics on frequency of visits and/or level of spend per visit to each provider type and/or sub-category.

6. The method according to claim 1, wherein the historical purchasing data is used to predict future customer spend patterns so that tailored deals, discounts, recommendations or rewards can be offered to the customer.

7. The method according to claim 1, wherein the step of obtaining data on the recognized customer may comprise reading data from a local source.

8. The method according to claim 1, wherein the step of obtaining data on the recognized customer may comprise remotely accessing the data.

9. The method according to claim 1, wherein a full purchasing history is made available to all service providers so each service provider can extract information relating to purchases at a plurality of service providers.

10. The method according to claim 1, further comprising considering all purchases relating to a particular provider type and/or sub-category.

11. The method according to claim 1, further comprising determining the customer's preferences and/or typical spending patterns by comparing the number and types of providers the customer has transacted with over a pre-defined time period.

12. The method according to claim 1, further comprising determining the customer's favorite restaurants or favourite types of cuisine at various times of the day, week, month or year.

13. The method according to claim 1, further comprising predicting the next time a customer is going to visit a particular provider of goods/services or a particular type and/or sub-category of provider.

14. The method according to claim 1, further comprising predicting the kind of items the customer is going to purchase from each provider and/or type and/or sub-category of provider.

15. The method according to claim 1, wherein the data is stored in a preference database.

16. The method according to claim 1, wherein the staff are informed of specific offers, incentives, or bundled offers, to provide to the customer based on the customer's historical purchasing data.

17. The method according to claim 1, further comprising analyzing data from a plurality of customers and providing information to one or more providers of goods/services based on one or more groups of customers.

18. The method according to claim 1, wherein the step of informing the staff comprises providing the data on an electronic device.

19. A computer system for providing a personalized customer service from a physical provider of goods or services comprising:
(i) a detector for recognizing when a customer enters a physical provider of goods or services through use of an electronic signature;
(ii) a database comprising data on the recognized customer, the data comprising the customer's historical purchasing data; and
(iii) a processor for informing provider staff of one or more of: the customer data, deals, discounts, recommendations or rewards to offer the customer based on the historical purchasing data, such that the staff can provide a personalized service to the customer based on the data provided.

20. A non-transitory computer-readable medium having stored thereon program instructions for causing at least one processor to perform the method according to claim 1.

21. A near-field communication (NFC) device for communicating an electronic signature identifying a customer when the customer enters a physical provider of goods or services.

22. An electronic device for informing provider staff of one or more of: customer data, deals, discounts, recommendations or rewards, to offer a customer, based on the customer's historical purchasing data, such that the staff can provide a personalised service to the customer based on the data provided.
